(19) United States
(12) Patent Application Publication
(10) Pub. No.: US 2018/0156428 A1
(43) Pub. Date: Jun. 7, 2018

(54) Lighting Device with Magnetic Attachment

(71) Applicant: Kenneth Shavar Ratley, Charleston, SC (US)

(72) Inventor: Kenneth Shavar Ratley, Charleston, SC (US)

(21) Appl. No.: 15/830,210

(22) Filed: Dec. 4, 2017

Related U.S. Application Data
(60) Provisional application No. 62/431,229, filed on Dec. 7, 2016.

(51) Int. Cl. F21V 21/096; F21K 9/20; F21V 23/00; A47B 97/00; F21S 9/02; F21V 23/04

(52) U.S. Cl. CPC F21V 21/096; F21K 9/20; F21V 23/009; F21Y 2115/10; F21S 9/02; F21V 23/04; F21V 23/006; A47B 97/00

(57) ABSTRACT

In broad embodiment, the present invention is a light with magnets on the top and bottom and a switch which may be operated by attaching and removing the bottom magnets to a surface.

### BACKGROUND OF THE INVENTION

The present invention relates generally to lighting for both decorative and functional purposes. More specifically, the present invention relates to flashlights, emergency lighting, and decorative lighting of the style typically used under cabinets, in bookshelves, and trophy displays.

Typically, lighting is limited to being either portable or fixed. In addition, the portable or fixed nature limits most lighting to one use. For example, the typical use of a flashlight is to provide illumination where a fixed light source does not exist or has lost power. The common cylindrical design of flashlights makes them unsatisfactory for other uses, especially decorative uses. On the other hand, under-cabinet lighting has both decorative and functional value. Still, most under cabinet lighting his permanently fixed using screws or adhesive. It is also often hardwired into the electrical system of the house. These limitations make it impossible to remove under-cabinet lighting and use it effectively as a flashlight in both emergency and non-emergency situations. Some under cabinet lighting uses battery power to make installation easier and less damaging to the surface to which the lighting is affixed, still battery powered under-cabinet lighting uses hardware, adhesive, or other fasteners that are not conducive to quick and non-damaging removal and reinstallation.

Moreover, the on/off switch for these types of lights limit their functionality and effectiveness. Commonly, these lights have a push-button, locking switch to turn them on and off. The switches may be located on the top (light emitting) surface, but doing so limits the surface area available to provide illumination. Switches located on the side of the fixture can be difficult to locate and reach once installed. Lastly, switches located on the electrical wire are similarly inconvenient. Some such lighting includes a motion sensor switch, which is an improvement for some uses but to be effective, requires that the light is mounted where motion can be sensed and also requires persistent or frequent motion input to remain lighted while in use. In addition, if the light is to be used for decoration, a motion sensor would not allow the light to remain on while the users are not within a prescribed proximity.

### SUMMARY OF THE INVENTION

The present invention is a battery powered disc or puck shaped lighting device with magnets on both the top—light emitting—and bottom surfaces to allow for convenient self-storage, easy operation, portability, and permanent or semi-permanent installation.

The present invention, in its most basic form, is shaped like a hockey puck. The bottom surface has an on/off switch, which turns the light on when the bottom side of the device is placed flat against a surface. When the bottom surface is placed against another surface, the switch is partially depressed. When removed from the surface, the switch returns to the off position. Thus, the device can be turned on and off by placing it, bottom down, on a surface. The switch may also be manually pressed fully, below even with the bottom surface of device, causing the light to “lock” in the on position. This allows the device to be used as hand-held light or to be mounted semi-permanently or temporarily to a surface. The device can be made in various sizes, shapes, voltages, and battery capacities. Both the top and bottom surfaces of the device have magnets which allowing the device to be attached to magnetic surfaces with either the top or bottom surface of the device facing the other surface. Thus, the device can be stored in the top down, off, position until needed and then simply flipped over in place to be turned on.

### BRIEF DESCRIPTION OF THE DRAWING

FIG. 1—Disassembled or “exploded” side view

FIG. 2—Side Assembled view (switch in off, default position)

FIG. 3—Side Assembled view (switch in “latched” on position)

FIG. 4—Side Assembled view, attached to surface bottom-side down (switch in momentary on position)

FIG. 5—Bird's Eye view, top (light emitting side) facing up

FIG. 6—Bird's Eye view, top (light emitting side) facing down

FIG. 7—three-dimensional design concept 1

FIG. 8—three-dimensional design concept 2

FIG. 9—three-dimensional design concept 3

FIG. 10—three-dimensional design concept 4

FIG. 11—three-dimensional design concept 5

FIG. 12—three-dimensional design concept 6

FIG. 13—three-dimensional design concept 7

FIG. 14—three-dimensional design concept 8

FIG. 15—three-dimensional design concept 9

### DETAILED DESCRIPTION OF THE INVENTION

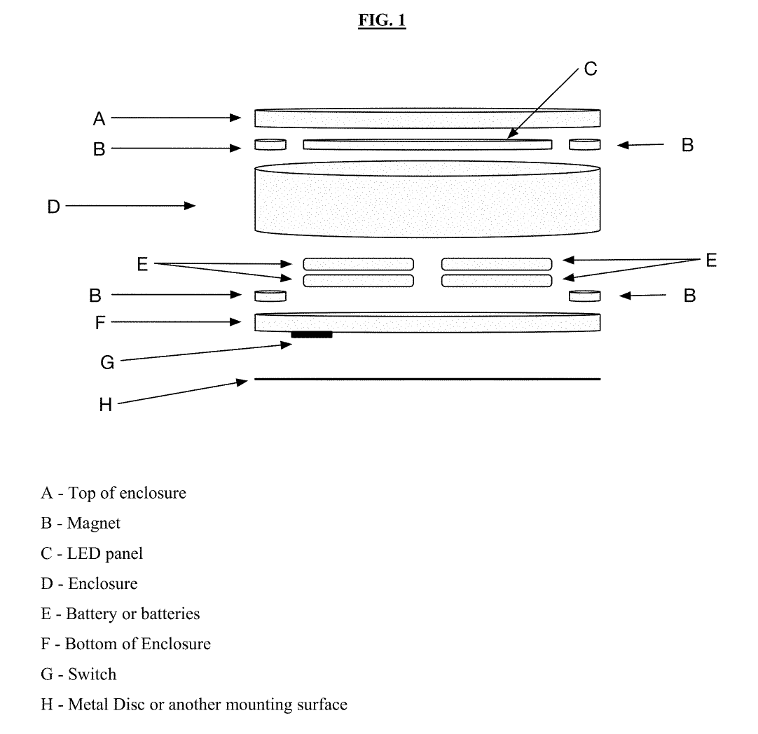

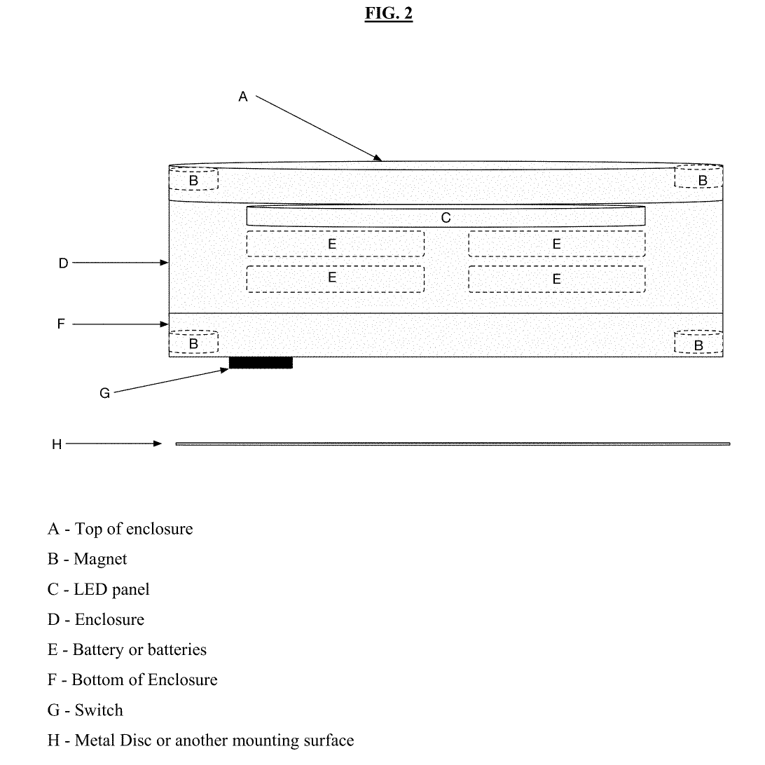

Referring to FIGS. 1 and 2, the invention consists of a battery-powered, puck-shaped light with magnets on the top and bottom sides. The bottom side of the invention has an on/off switch, which protrudes slight beyond the surface. The area of the bottom surface surrounding the switch is slightly indented to allow an operator of the invention to depress the button below even with the rest of the surface.

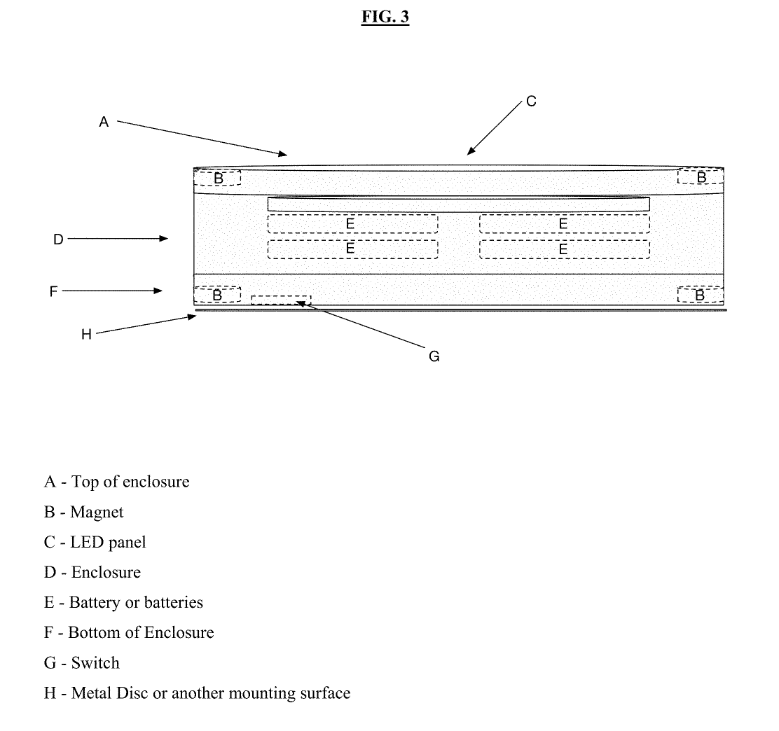

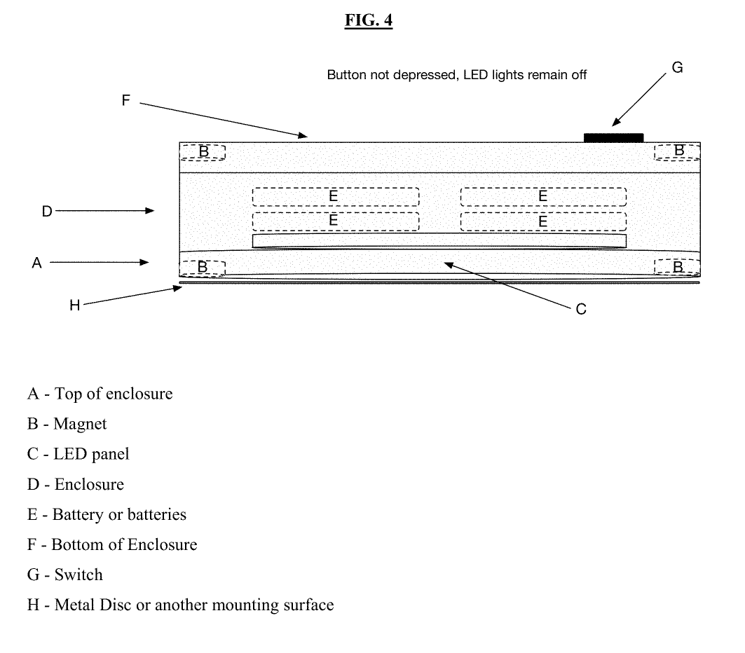

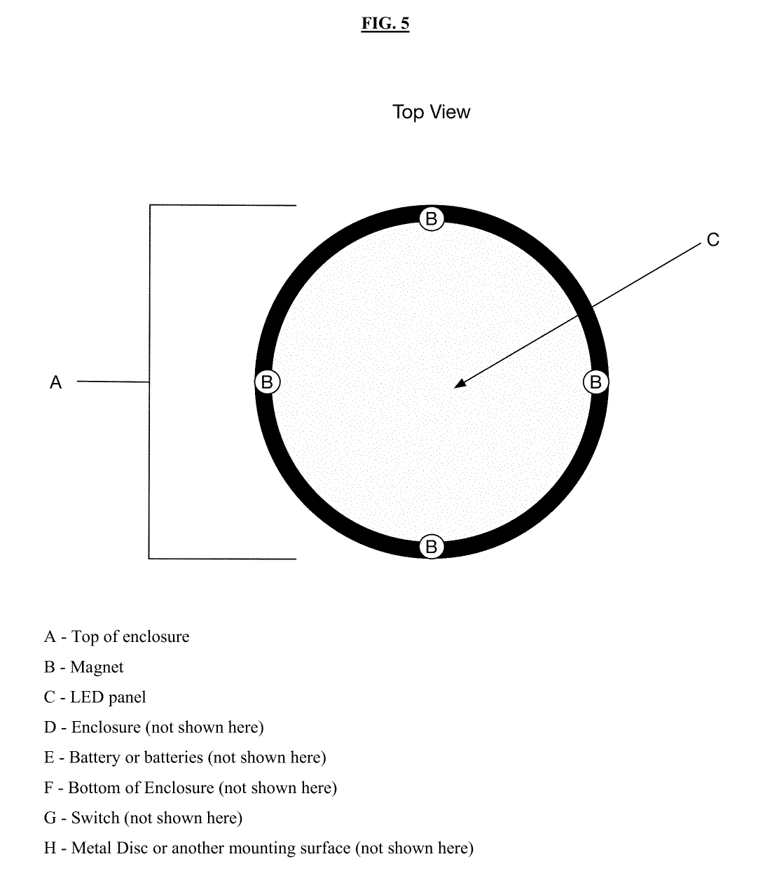

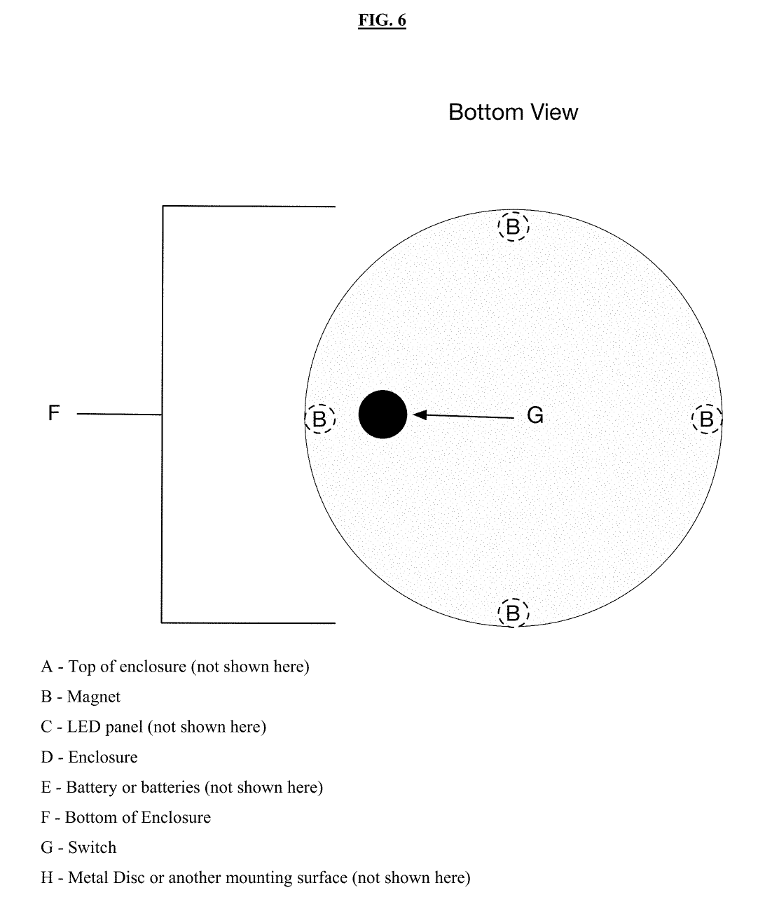

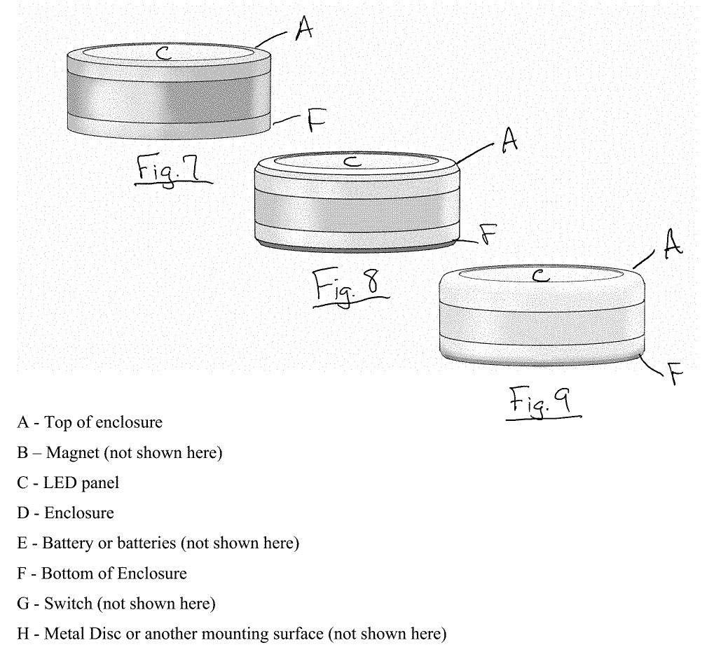

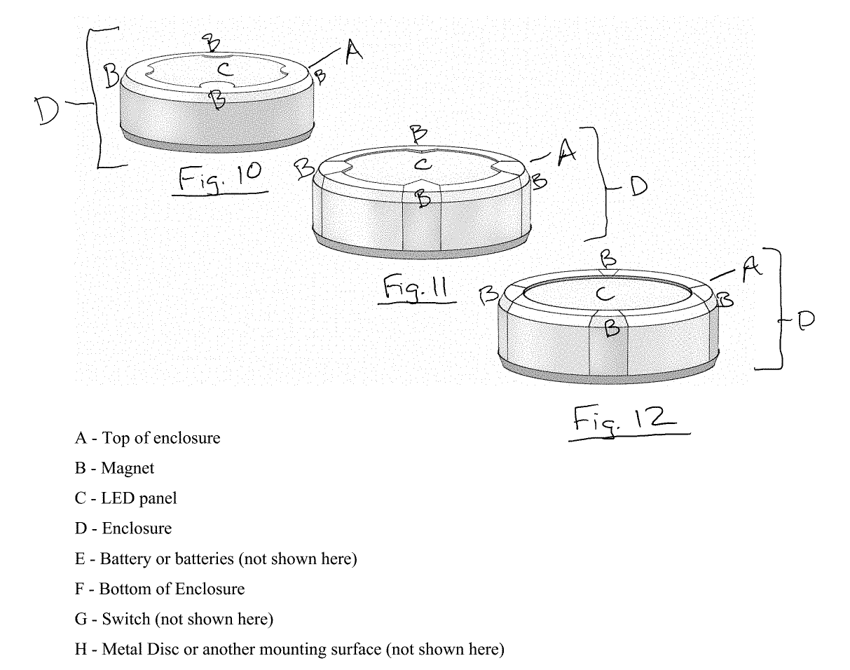

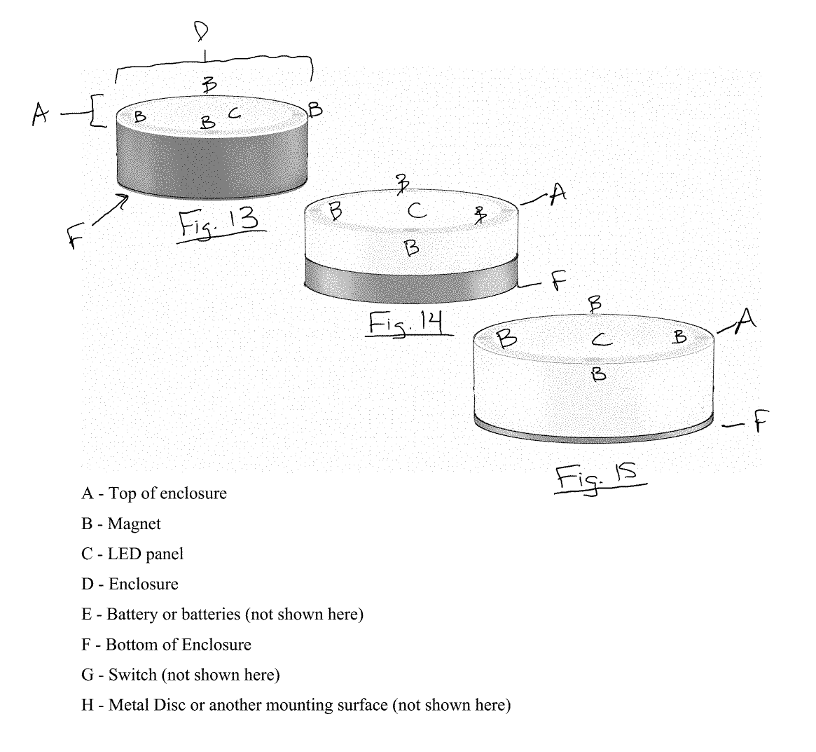

Referring to FIGS. 2 and 3, when depressed fully, the switch locks in the on position until depressed again. When the switch is depressed such that it is even with the bottom surface it remains in the momentary on position. This may be done manually be the operator or by being placed with its bottom against a surface. The magnets allow the invention to be attached in various orientations and be operated hands-free.

Referring to FIGS. 3 and 4, the invention can be turned from off to on and vice-versa, simply be flipping it over. This allows for operation without having to see the invention to locate the switch or feel around the invention to locate the switch, as is the case with other lights. In addition, the magnets allow the invention to be stowed in the location of its intended use and then simply flipped over when needed. The magnetic attachment capability also allows the device to be used as a hands-free head lamp, attached to a metallic belt buckle, neck-lanyard, badge and any other such apparatus to which a metal disk may be attached.

The advantages of the present invention include, without limitation, that it is portable and exceedingly easy to transport. It is easy to operate due to the ability to turn it on and off by simply flipping it over rather than by pressing a button manually, although manual operation is possible in circumstances where doing so is beneficial. Further, the device can be attached to a variety of surface and various orientations. Further, the device may be attached to accessories equipped with an appropriately sized and shaped magnetic disc so that it may be used as a headlamp, for example. It may also be attached to metal discs attached in bookshelves and use for decorative illumination.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A lighting device, comprising:
An enclosure containing a light emitting diode or bulb and batteries and having magnets on the top and bottom surfaces of sufficient strength to hold the device attached to magnetic surfaces, a switch located on the bottom surface and protruding from the bottom surface, the surface opposite the light emitting surface, whereby said switch is depressed evenly with the bottom surface when the bottom surface is placed against another surface causing the light to turn on, said switch returns to its off position when the bottom surface is removed from another surface.

2. Said switch of the invention of claim 1 may be manually depressed beyond the bottom surface by the user causing it to remain on while either attached to a surface or detached from a surface until manually depressed again to turn off.
